(19) United States
(12) Patent Application Publication
(10) Pub. No.: US 2019/0027944 A1
(43) Pub. Date: Jan. 24, 2019

(54) USB Charging Station

(71) Applicants: Brian Grzybowski, Hibbing, MN (US); Todd P. Bigelow, Hibbing, MN (US); Christopher Stevens, Hibbing, MN (US)

(72) Inventors: Brian Grzybowski, Hibbing, MN (US); Todd P. Bigelow, Hibbing, MN (US); Christopher Stevens, Hibbing, MN (US)

(21) Appl. No.: 15/652,634

(22) Filed: Jul. 18, 2017

(51) Int. Cl. H02J 7/00

(52) U.S. Cl. CPC H02J 7/0027; H02J 7/0045

(57) ABSTRACT

A charging station for charging a plurality of electronic devices is disclosed. The charging station may be accessible or securable. The station may include a housing in the form of a set of shelves, a closeable and lockable cabinet, a mobile cart and/or a protective case. The housing has at least one surface for receipt of a plurality of electronic devices. The station includes an electrical charging assembly in electrical communication with a plurality of charging ports. The plurality of charging ports being positioned within the housing and adjacent to the at least one surface that receives electronic devices. The station has a set number of charging ports of which each may electronically engage and provide an electrical charge to an electronic devi.

### FIELD OF THE INVENTION

The present disclosure is directed to charging stations for portable electronic devices such as cellular telephones (i.e. smart phones), electronic tablets and the like. More specifically, the present disclosure is concerned with a charging station capable of holding and charging numerous such devices simultaneously, and in at least some embodiments providing a secure environment where such devices are kept while being charged.

### SUMMARY

There are numerous environments where individuals are asked or required to give up their portable electronic devices to a third-party authority. For example, some participants in sporting events at the college and high school level are often required to keep cell phones out of locker rooms, but typically no place is provided to the participant to leave his or her phone during the sporting event. The present disclosure is directed to a solution that provides not only a single location where multiple electronic devices may be stored in such electronics restricted environments, but also to allow electronics stored therein to be charged while being retained en masse. By providing not only a central and potentially secure location, but also a charging service to the prohibited devices during the event or time period required, it is believed that the willingness to comply with such electronics prohibitions will be improved.

### DESCRIPTION OF THE RELATED ART

Charging stations for charging multiple smart phones and other electronic devices are well known. An example of one such device is disclosed in U.S. Pat. No. 9,509,153 which describes a charging station to which up to eight devices may be simultaneously charged. The charging station described in the '153 reference, includes up to 8 ports by which devices may be plugged into by cords that may extend up to two feet from the station with the devices being charges simply placed within that limited proximity.

Embodiments of the charging station described herein improves upon such prior charging stations in almost every way. For example, embodiments of the present charging station provides simultaneous charging of up to forty smart phones or similar electronic devices rather than a mere eight. Some embodiments provide a housing into which smart phones may be contained in an organized and secure manner while they are being charged. In some embodiments, the charging station is completely portable, even when fully “loaded” with a full complement of electronic devices being charged.

### BRIEF DESCRIPTION OF THE DRAWINGS

FIG. 1 is a side view of an embodiment of the invention.

FIG. 2 a cut-away perspective view of a shelf of the embodiment shown in FIG. 1.

FIG. 3a is an illustration showing the use of a cord in connecting a portable electronic device to one of the ports shown in the embodiment of FIG. 1.

FIG. 3b is an illustration showing direct connection of a portable electronic device to one of the ports shown in the embodiment of FIG. 1.

FIG. 4a is a partial cut-away view of the embodiment shown in FIG. 1, wherein a power supply and the manner in which it is connected to charging points is shown.

FIG. 4b is a block diagram illustration of an embodiment shown in FIG. 4a, wherein multiple power supplies are a utilized, with each power supply providing power to a set number of charging ports.

FIG. 5 is a perspective view of the embodiment shown in FIG. 1 wherein the housing is provided with a lockable door.

FIG. 6 is a side view of the embodiment shown in FIG. 1 wherein the housing is provided with wheels, etc. and is made mobile in the manner of a cart.

FIG. 7 is a perspective sectional view of an embodiment wherein the housing is a cabinet loadable from two sides.

FIG. 8 is a perspective view of an embodiment wherein the housing is a portable case.

FIG. 9 is a top down view of the base portion of the case shown in FIG. 8 and illustrating the alternating arrangement and orientation of the electronic device receptacles therein.

### DETAILED DESCRIPTION

As indicated above a USB charging station for supplying power or “charging” multiple electronic devices such as cell phones, personal data assistants, note pads, electronic tablets and even personal computers is provided herein with some of its various embodiments described in detail.

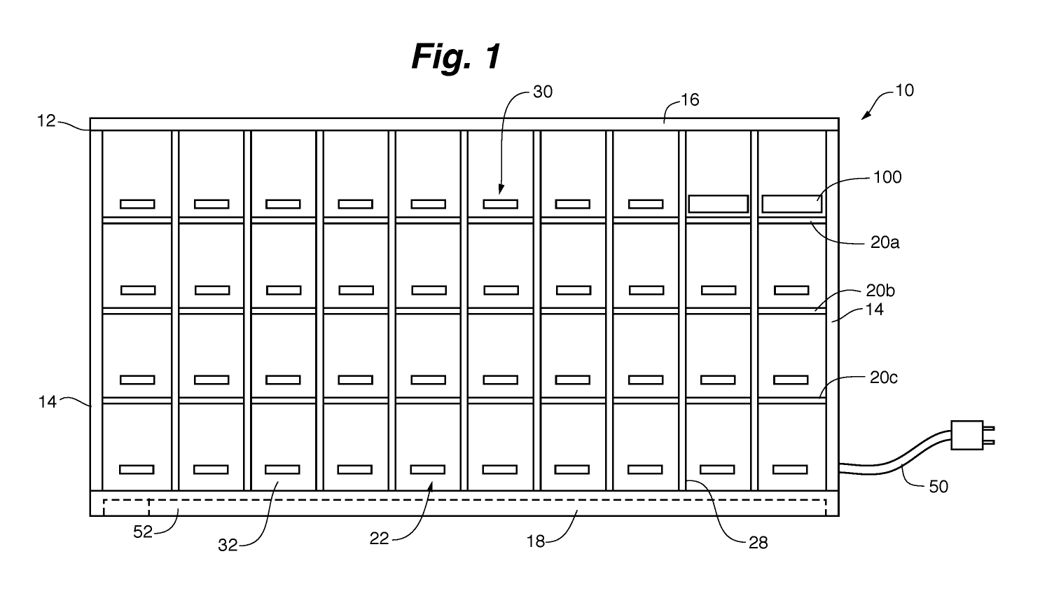

Turning to FIG. 1, an embodiment of the charging station 10 is shown which is comprised of a housing 12 this has a square or rectangular frame of side walls 14, a top panel 16, and a bottom panel 18. The housing 12 also has a plurality of shelves 20a, 20b, and 20c. The charging station 10 may be considered to have a front side and back side through which a user my load an electronic device 100 onto one or more charging ports 30 that are positioned adjacent to, and run along the length of each shelf 20a-20c; though in the embodiment shown in FIG. 1, only the front side 22 is visible and accessible by a user. Each shelf is capable of storing, electrically engaging, and charging multiple electronic devices, with 10 different charging location being shown in FIG. 1. This embodiment includes four shelves (shelves 20a-20c and bottom panel 18 acting as a “shelf”).

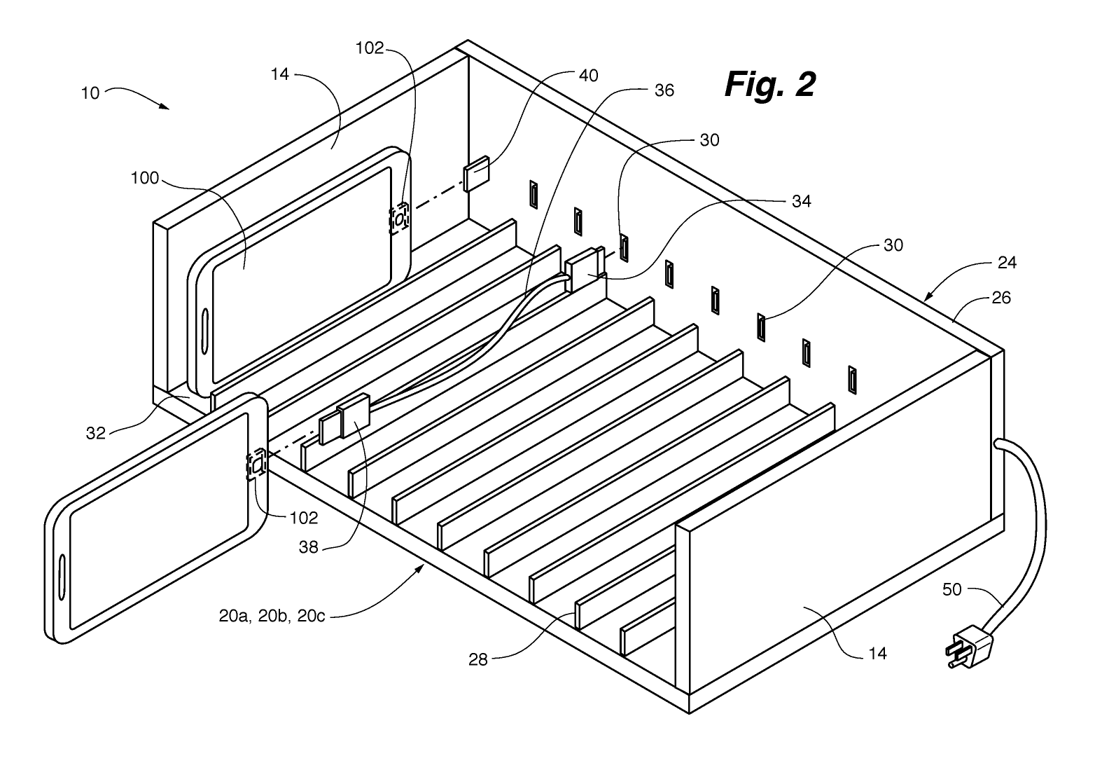

In FIG. 2, a detailed view of one of the shelves 20a-20c is shown. Here it may be seen that in at least one embodiment, the back side 24 of the charging station 10 comprises a wall panel 26 into which the charging ports 30 are positioned. Though not structurally necessary, each shelf 20a-20c may include multiple partitions 28 which extend entirely (see FIG. 1) or partially (see FIG. 2) between adjacent shelves (e.g. 20b to 20a), top panel 16 (e.g. 20a to the top panel 16) or bottom panel 18 (e.g. bottom panel 18 to shelf 20c) to provide each device 100 with its own defined charging area, base or cubby. Such defined charging areas 32 provide for improved organization of the devices stored and encourages users to more readily recall where in the station 10 their specific device is stored.

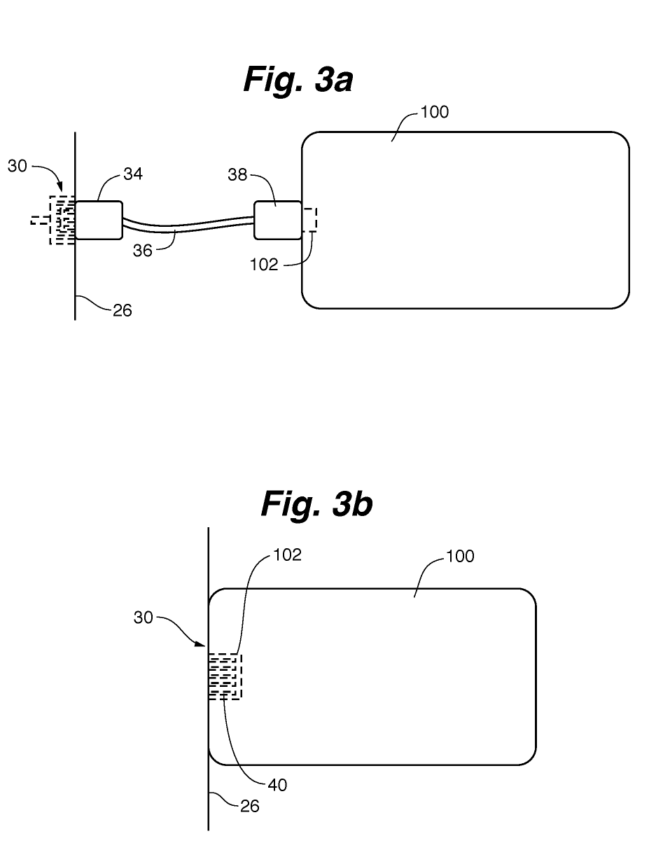

The manner in which devices 100 are charged by the station may vary. For example, in the embodiment shown in FIG. 2 a first type of charging port 30 is shown which includes a standard USB port. USB ports include a five volt power line that is used by many manufacturers to power or recharge portable electronic devices. Standard USB ports can be connected to by a variety of cables or adapters, which can supply power to Lightning connectors (a proprietary computer bus and power connector created by Apple Inc. of Cupertino, Calif.), Micro-USB connectors, or other types of electronic connector (USB or otherwise) suitable for providing an electric charge to small portable electronic devices of the type described above. This conventional connection includes a female port 30 into which a first male adapted end 34 of a power cord 36 is plugged into. The other end 38 of the power cord is then plugged into the power/data port 102 of an electronic device 100. A more detailed view of this type of connection arrangement is shown in FIG. 3a In other embodiments, the female port 30 is not a standard USB port, but is any other port capable of supplying power through a cable to a portable electronic device 100.

In an alternative embodiment, at least some of the ports 30 are configured for uniform direct connections to specified electronic devices 100, such as smart phones having a specific size/shape/geometry and a specific type of USB connection. In this alternative embodiment, the device 100 is plugged directly into a male extending jack 40 which may be a male USB adapter plugged into the conventional female port 30 or which may be male jack hardwired and secured into the back wall panel 26 of the station 10. This type of arrangement would allow the station 10 to have a very compact design, and avoid the need of additional cords 36 with which to engage the devices 100 to the ports 30. A more detailed view of this type of direct connection arrangement is shown in FIG. 3b.

In yet another embodiment, one or more of the charging areas 32 may be provided with inductive charging surfaces which provides an electromagnet field to the specified charging area 32 so as to charge the device 100 located therein. While inductive charging is considered less efficient that direct charging, such inductive charging areas would allow the area 32 to avoid the need of a cord 36 or even a port 30, as well as accept a wide range of devices without concern for proper connection or adaptors. In such an embodiment, a defined region of the respective shelf that defines the charging area 32 functionally acts as the charging “port” 30. In this embodiment, it may be wise to ensure that portable devices lay flat against the charging area 32 in a horizontal position (as shown in FIG. 1) as opposed to being positioned on their ends in a more vertical position (as shown in FIG. 2).

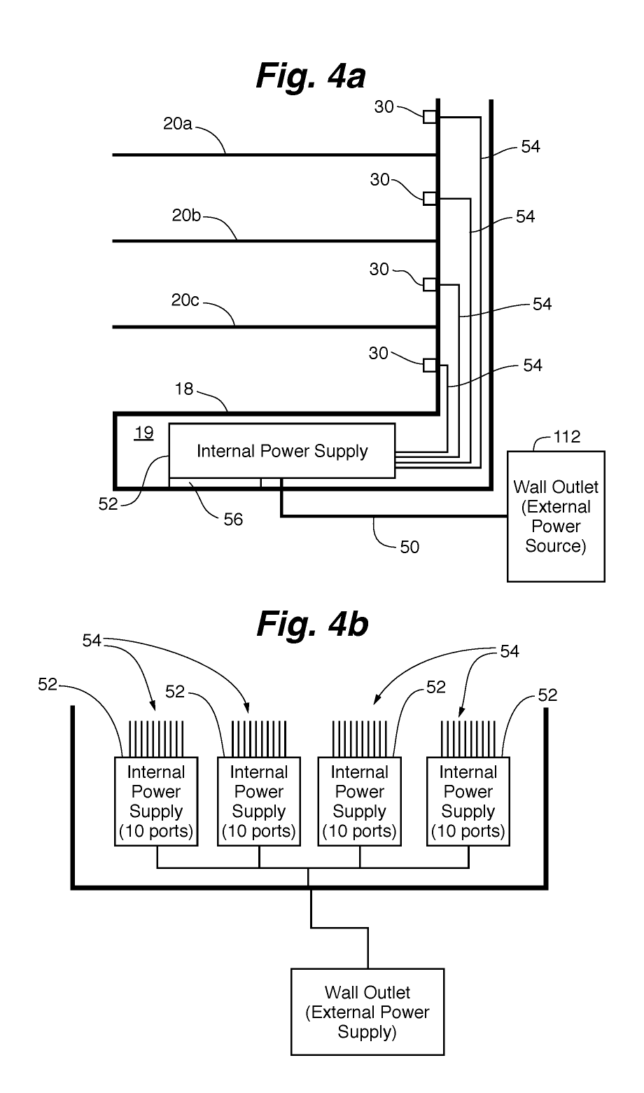

The station 10 includes various mechanisms that form an electronic charging assembly for communicating electrical current from an external power source to the electronic devices that are stored and electronically engaged to the charging ports 30. The actual communication of electric current through this assembly starts with an external power source 112, and passes through an external power plug and cable 50 to an internal power supply 52. The internal power supply 52 converts the alternating current from the wall outlet 112 into DC voltage appropriate for the portable electronic devices 100. In the preferred embodiment, the internal power supply is designed to provide power to multiple USB female ports built into, or positioned adjacent to, the power supply 52. For example, in the embodiment shown in FIG. 4a power from the USB ports on the power supply runs over USB cables 54 to the various charging ports 30 located at or above the shelves 20.

As is illustrated in FIG. 4a, in some embodiments, each power supply 52 is in electrical communication (via USB cables 54) with one or more of the charging ports 30 of the base 18 and each of shelves 20a, 20b and 20c. In at least one embodiment, each power supply 52 includes USB cables 54 that vertically extend to connect at least two charging ports 30 of the base 18 and each shelf 20a, 20b and 20c. In at least one embodiment, each power supply 52 is in electrical communication with 10 charging ports 30 that are distributed on all four of the charging areas 32 of the base, and each shelf 20a, 20b, 20c.

In one embodiment, each USB cable 54 is a male-to-female USB extension cable, with the male end plugged into a USB port on the internal power supply and the female port mounted on the back wall panel 26 of each charging cubby, as is depicted in FIG. 4a. In one embodiment, the back wall panel 26 is a single metal sheet, and the female ports are mounted through holes in the metal sheet.

In at least one embodiment the internal power supply 52 is positioned beneath or within the bottom panel 18. FIG. 4a shows an opening or cavity 19 beneath the bottom panel 18 which contains the internal power supply 52. In order to control the build-up of heat within this cavity 19, a heat sync 56 can be installed to create thermal connectivity between the power supply and the housing 12. In this case, the housing 12 is preferably made of steel or other thermally conductive material. The housing 12 will then dissipate the heat generated by the power supply 52 across a wider area of the housing surface.

In at least one embodiment, the heat sync 56 is unnecessary because the power supply 52 does not generate significant heat. Ten-port USB power supplies are manufactured by many parties. For instance, Sabrent of Los Angeles Calif. manufacturers a 10 port, 60 watt (12 Amp) charger that can be utilized in the disclosed embodiment without generating significant heat in the cavity 19. Because of the wide availability of off-the-shelf 10-port USB power supplies, one embodiment of the present invention supplies power to 40 charging cubbies by utilizing four separate power supplies 52, as shown in FIG. 4b. The four power supplies 52 are connected to a single external plug, and each provide power to ten different USB cords 54 (and hence ten different charging ports 30).

In one embodiment, a battery or series of batteries (not shown) may be provided within the confines of the housing 12. These batteries can store the power received from the power source 112 for subsequent powering of the charging ports 30 when the power cable 50 is not attached to a wall outlet 112.

Returning to the embodiment shown in FIG. 1, here a version of the station 10, is shown that is “open faced” or is freely accessible from a single side of the station wherein electronic devices 100 may be inserted and removed from their respective charging areas 32 with no restriction. In such an embodiment, the station 10 may be free standing or may be mounted on a wall via any sort of securement system (fasteners such as screws, hooks, etc.). Such an unsecured or open version of the station may be suitable for use in environments such as classrooms, where constant supervision of the station 10 is generally expected while the station contains devices 100.

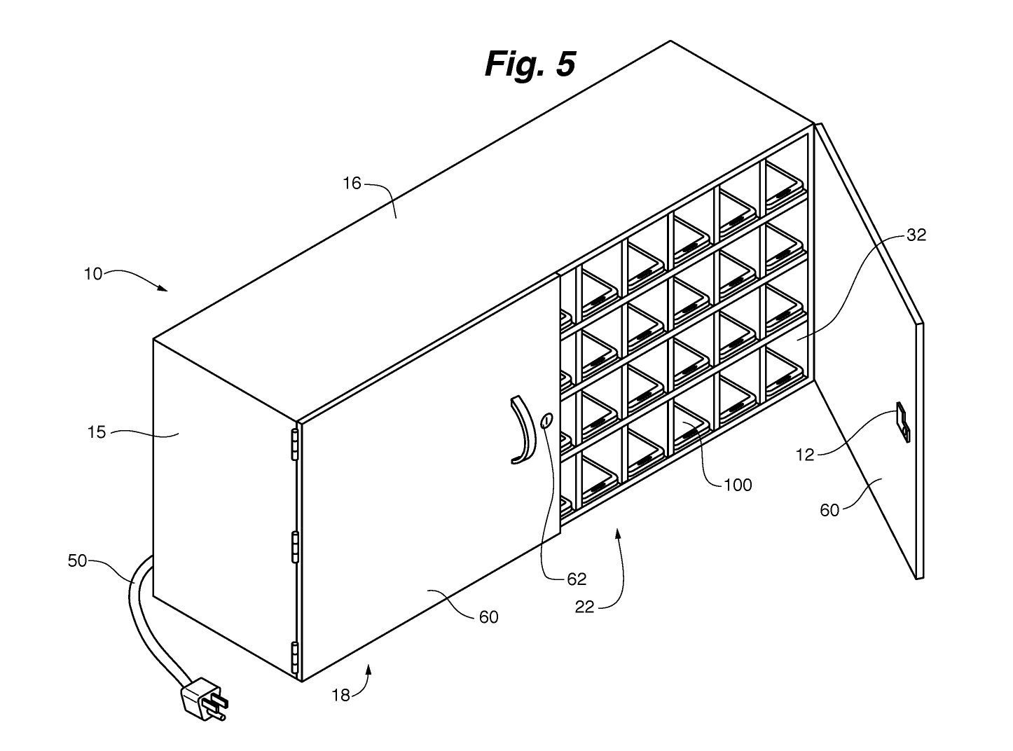

In another embodiment, an example of which is shown in FIG. 5, the station 10 is fitted with a door or doors 60 that extend across the normally open front side 22 and which are actuatable between an open state wherein the charging areas 32 and any devices 100 stored therein are readily accessible; and a closed state, wherein the interior of the station's charging areas 32 (and any devices 100 contained therein) are secured from passersby. In at least one embodiment, the door or doors 60 are provided with a lock 62, which allows the station's interior to be made even more secure from casual access. Such a lockable, more secured version of the station 10 may be suitable for use in more public environments such a locker rooms or any area where secured storage and charging of electronic devices 100 is desired. In such an embodiment, a responsible individual or individuals (e.g. a coach or teacher) will have possession of the key or code necessary to access the station interior on behalf of a device owner whose devices is contained therein (e.g. a student). This embodiment is ideal for locker room situations, where all attendees in a gym class, or all participants in a sporting event, are required to leave their phones outside the locker room. The coach or teacher could secure the entire station 10 at once, and keep it secure until the class or sporting event is complete. In other embodiments, individual device owners may be granted lock access.

A further embodiment of the doors 60 shown in FIG. 5 is the ability to implement the doors as part of a complete metal enclosure around the devices 100. Such a metal closure has the benefit of significantly reducing or blocking the ability of the devices 100 to receive cellular signals. In a classroom situation, this could prevent cellular calls and messages from being received by the devices and potentially triggering disruptive rings, signals, or noises in the devices 100.

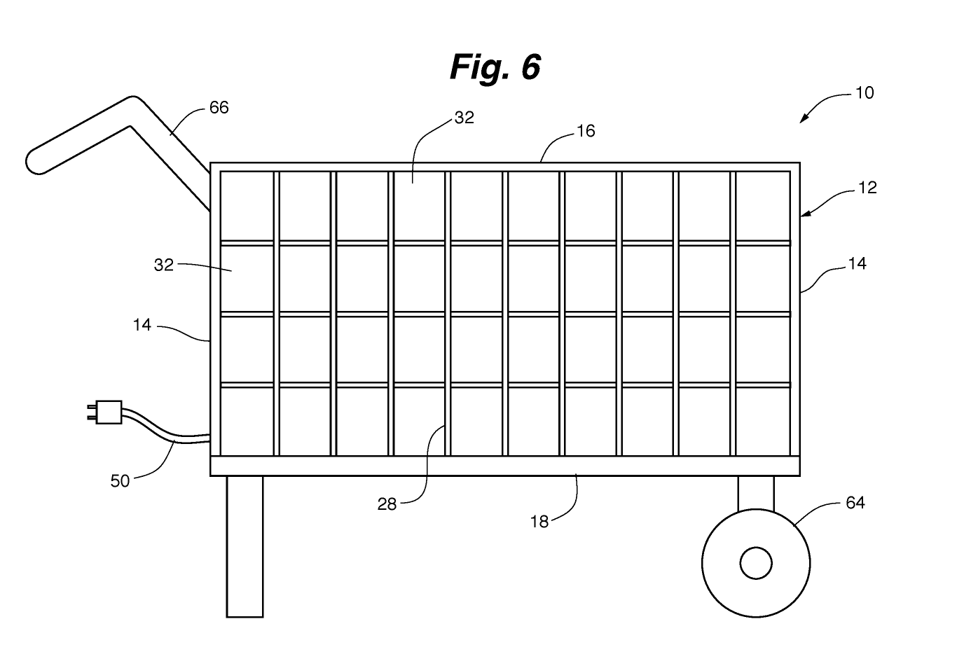

In yet another embodiment of the station 10, an example of which is shown in FIG. 6, the housing 12 of the station 10 is provided with a pair of wheels 64 or castors as well as a handle 66. These additions effectively make the station 10 into a mobile cart that may be moved or repositioned as desired.

In some embodiments, it may be desirable to allow devices 100 to be inserted into the station 10 from both the front side 22 and back side 24, such as in the manner shown in FIG, 7. Here, rather than positioning charging ports 30 along the back panel 26 (such as is shown in FIG. 2) the station 10 is provided with a central partition 68 in which the ports 30 are located. By providing a central partition 68, charging areas may be provided on either side of the station; and thus allow devices 100 to be inserted onto a shelf 20a-20c from either the front side 22 or back side 24. In these embodiments, it can be useful for the central partition 68 to be hollow, and run USB extension cables 54 from the power supplies 52 to the charging ports 30 through this central partition 68.

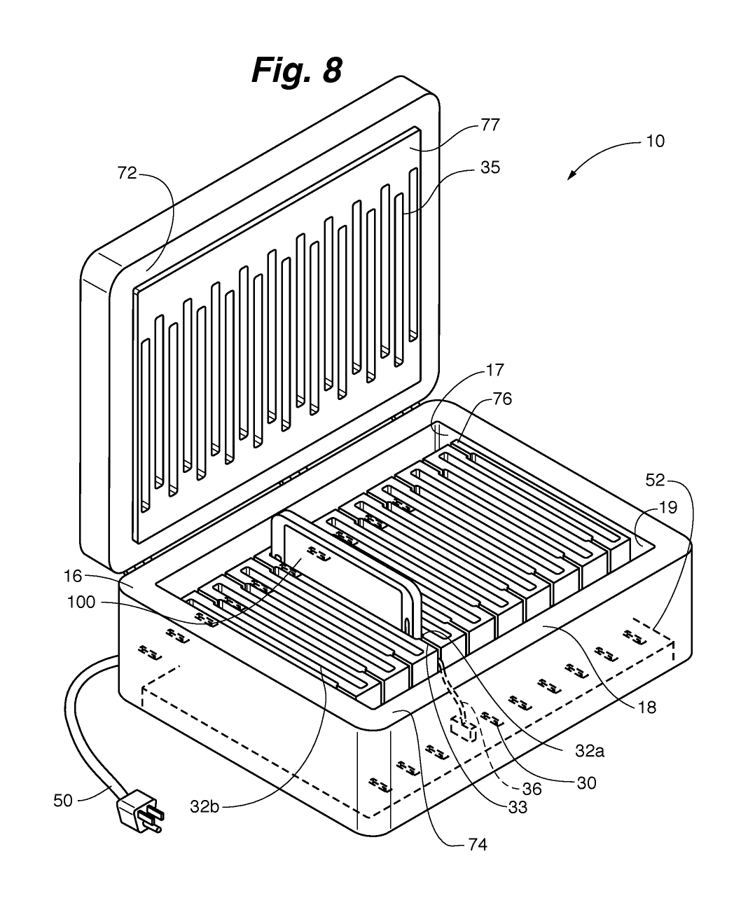

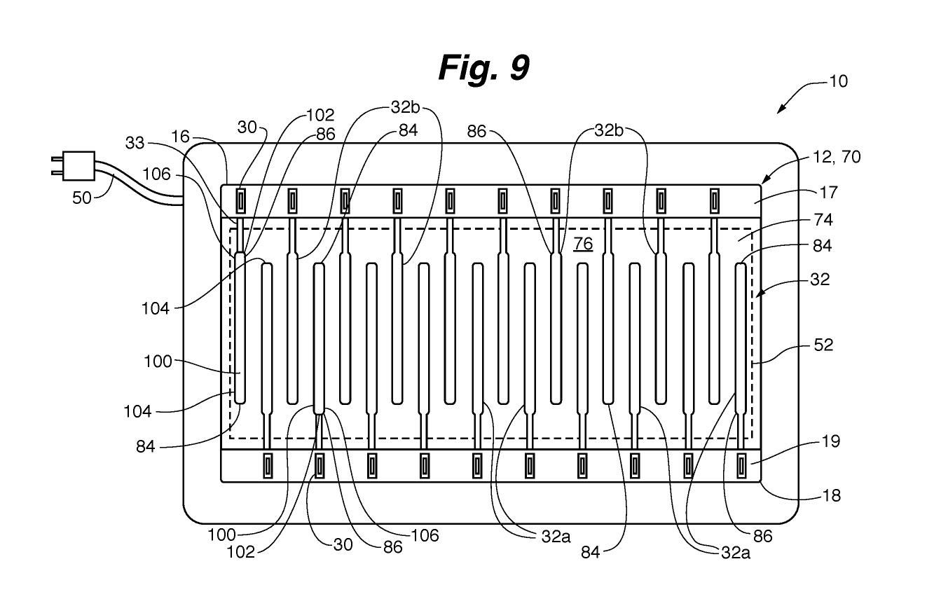

For the ultimate in mobility and protection, yet another embodiment of the station 10 is provided with a housing 12 that is in the form of a portable case 70 shown in FIGS. 8 and 9. In the embodiment shown, the housing 12 is a case wherein the front side of the case 22 includes a case lid 72 that functions in the same manner as the door 60 such as is shown in FIG. 5. The case 70 includes protective material 76 that defines the charging areas 32 for a set number of electronic devices 100.

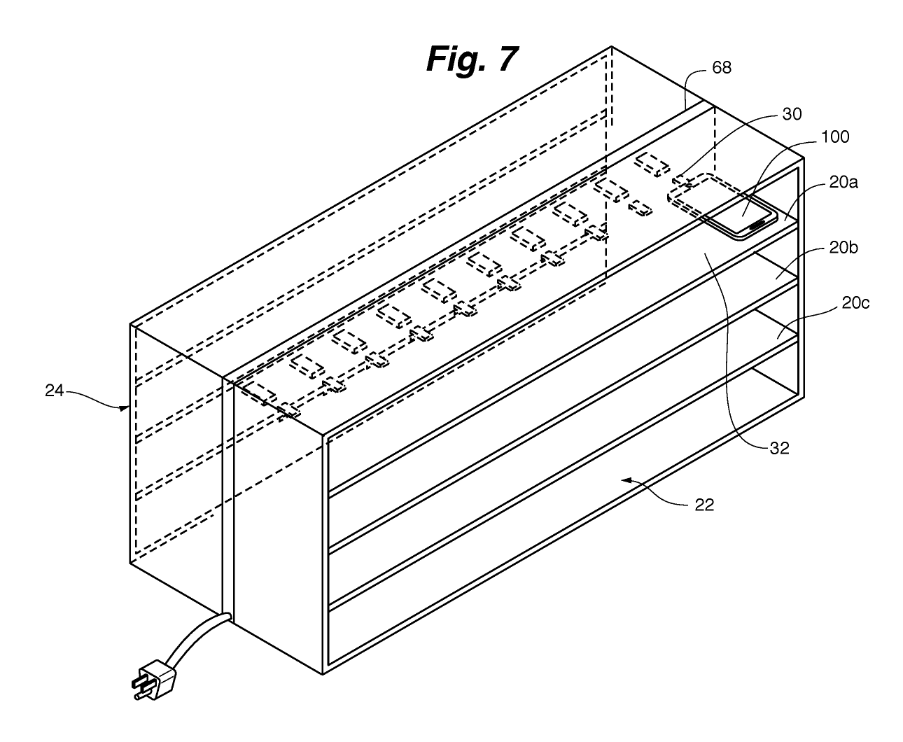

In some embodiments, rather than provide a plurality of shelves (20a-20c shown in FIGS. 1-2 and 5-7) for the storage and charging of devices 100, the portable case 70 may include multiple layers 74 of protective material, with each layer 74 capable of securing, storing, and charging a plurality of devices 100. These layers 74 may be stacked one on top of the other depending on the size of the case and the number of devices that are to be stored and charged therein. For ease of illustration, in the embodiments shown in FIGS. 8 and 9 only a single layer 74 is depicted wherein the layer includes twenty charging areas 32. Though the number of charging areas provided to the layer may be vary as desired.

The charging areas 32 are defined by and within a protective material 76 such as foam, flexible plastic or other impact absorbent material. In one embodiment, the foam is made from electrostatic-discharge (or “ESD”) safe material, such as conductive foam (such as conductive crosslink or conductive urethane foam) or dissipative foam (such as dissipative crosslink or dissipative urethane foam). This foam can be cut into a desired shape through a water-jet or laser cutting process. In FIG. 9, the foam 76 has been cut into 20 different charging areas 32.

Each charging area 32 has a shape corresponding to that of the shape of the device 100 to be inserted therein. More particularly, the width of each charging area is approximately equal to the depth of each device 100 when the device is laid on its back or front. The length of each charging area 32 is approximately equal to the height of each device 100. In the preferred embodiment, a plurality of different devices 100, such as cellular phones, can be inserted into the plurality of charging areas 32, with the different devices 100 having different heights and widths. In this case, it is preferred that the length of each charging area 32 be long enough to handle the largest height of the anticipated devices. However, the width of each charging area 32 does not need to be as wide or wider than the depth of the deepest device 100, as the protective material 76 will be expected to be deformable to handle a device 100 deeper than the width of the charging area 32.

At the present time, most electronic devices have a defined top 104 and a bottom 106, wherein the power/data port 102 (e.g. USB, lightning, etc.) is positioned at the bottom 106 of the device 100. The charging areas 32 of the case 70 have a similar top and bottom orientation, wherein the top 84 of the charging area 32 corresponds with the top 104 of the device 100 and the bottom 86 of the area 32 corresponds with the bottom 106 of the device 100 to be inserted therein.

As can be best seen in FIG. 9 the lateral arrangement of the charging areas 32 alternates across the length of the layer 74. In particular, the bottom 86 of every member of the first set of charging areas 32a are closer in proximity to the top panel 16 and the bottom 86 of every member of the second set of charging areas 32b are closer in proximity to the bottom panel 18; with each charging area 32a alternating with an adjacent charging area 32b. This alternating pattern of charging areas 32a and 32b, corresponds to the position of the charging ports 30 that are positioned along the length of the top access channel 17 and bottom access channel 19. FIG. 8 also shows an alternating pattern in the charging area 32.

In FIGS. 8 and 9, the charging ports 30 are located at the bottom of a top channel 17 and a bottom channel 19 that are located on opposite sides of the protective material 76. These channels 17, 19 run along the entire width of the layer 74 on both sides of the protective material 76. The channels 17, 19 are sized to allow a human hand to reach into the channel 17, 19 while holding the end of a charging cord 36 (which may take the form of a USB plug) and insert it into the charging port 30. The plurality of charging ports 30 are arranged so that a single charging port 30 is located adjacent the bottom side of each charging area 32. The alternating pattern of charging areas 32a and 32b corresponds to the position of the charging ports 30 that are positioned along the length of the top access channel 17 and bottom access channel 19.

In FIGS. 8 and 9, each charging area 32 has an extension 33 at its bottom 86 into which the charging cord 36 can be inserted when the device 100 is inserted into the charging area 32. These extensions 33 run from the bottom end 86 of each charging area 32 into the immediately adjacent channel 17, 19. With properly sized charging cords 36, a device 100 can be plugged into a charging cord 36 (that has already been inserted into the charging port 30) and then placed into the charging area 32. The cord 36 attached to the device will simply slide into the extension 33 for that charging area 32, making the entire assembly more manageable. Furthermore, if the cords 36 are properly sized, the cords 36 attached to devices 100 already in the charging area will not extend above the surface of the protective material (as can be seen in FIG. 8) with only unused cords 36 extending out of the channels 17, 19. In the preferred embodiment, the extensions 33 are cut into the protective foam at the same time the charging areas 32 are created.

In at least one embodiment the case 70 includes a back panel 26 behind which the internal power supply or supplies 52 is positioned. Much as was described in connection with FIGS. 4a and 4b, each power supply 52 connects to a plurality of charging ports 30 behind the back panel 26, and all power supplies 52 can be wired to connect to a power source through a single power plug 50.

Regardless of the orientation of the charging areas 32 or the devices 100 contained therein, the protective material 76 frictionally engages devices inserted in to the charging areas 32. In some embodiments, an example of which is shown in FIG. 8, the lid 72 includes additional protective material 77 as well. In one embodiment, the material 77 of the lid 72 also includes and defines what are essentially top-portions 35 of the charging areas 32, such that when the lid is closed, any portion of the devices 100 extending upward out of the confines of the charging areas 32 are further engaged and surrounded by the top-portions 35 of the lid 72. In other embodiments, the material 77 of the lid 72 is compressible so that it is compressed when it engages mobile devices 100 when the lid 72 is closed. For example, the material 77 of the lid 72 could be a compressible foam that is cut into an egg-carton shape. When the lid 72 is closed, the compressible foam will hold the mobile devices 100 in place.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A charging station comprising:
a) a housing, the housing having:
i) at least one surface for receipt of a plurality of electronic devices, and
ii) an internal cavity;
b) an electrical charging assembly, the electrical charging assembly including:
i) a plurality of power supplies positioned in the internal cavity of the housing,
ii) a plurality of power supply cords,
iii) a plurality of charging ports positioned within the housing and adjacent to the at least one surface, each of the plurality of charging ports being in electrical communication with one of the plurality of power supplies via one of the plurality of power supply cords, and
iv) a single primary power cord and plug being in electrical communication with the plurality of power supplies, the primary power cord and plug being constructed and arranged to electrically engage a power source.

2. The charging station of claim 1, wherein the at least one surface is a base of the housing, the base having the internal cavity containing the plurality of power supplies.

3. The charging station of claim 2, wherein the housing is a cabinet, the at least one surface comprises a plurality of shelves within the cabinet, the plurality of shelves being positioned vertically above the base wherein the base acts as a first shelf.

4. The charging station of claim 3, wherein each shelf is sized to receive a subset number of the plurality of electronic devices and each shelf having the same subset number of the plurality of charging ports.

5. The charging station of claim 4, wherein the charging ports of each shelf are arranged in at least one row, each of the charging ports within the at least one row being equidistant from one another.

6. The charging station of claim 4, wherein the cabinet is constructed and arranged to charge 40 electronic devices simultaneously and wherein four power supplies each supply power to 10 charging ports.

7. The charging station of claim 3 wherein the cabinet is rectangular further comprises five walls and a single side into the cabinet, and at least one access door for operatively covering the single open side into the cabinet, the at least one access door having a locking mechanism configured to secure the at least one access door in a closed and locked position, when the at least one access door is in the closed and locked position access to the plurality of shelves is prevented from outside of the cabinet.

8. The charging station of claim 7, wherein the five walls and door each comprise a metal sheet collectively capable of substantially preventing cellular signals from reaching the interior of the charging station.

9. The charging station of claim 3 further comprising at least two wheels, the at least two wheels being mounted to a base of the cabinet.

10. The charging station of claim 3 wherein each of the plurality of power supplies is in electrical communication with at least two charging ports on each shelf.

11. The charging station of claim 1 wherein each of the plurality of charging ports being selected from the group consisting of a USB port, Micro USB port, Lightning port, and any combination thereof.

12. The charging station of claim 1 wherein at least one charging port comprises an inductive charging surface.

13. The charging station of claim 1, wherein each of the power supply cords comprises a USB extension cord with a male end and a female end, wherein the male end plus into one of the power supplies, further wherein the female end comprises one of the charging ports.

14. A portable charging station comprising:
a) a housing, the housing being a case having a top panel, a bottom panel, two side panels, a back panel, and a lid;
b) at least one power supply located within the housing;
c) electrostatic-discharge-safe foam material positioned above the at least one power supply, the foam material having a plurality of charging areas arranged in a single row extending between the two side panels, each of the plurality of spaced apart charging areas having a length and width sufficient to receive a single electronic device;
d) a top channel running between the top panel and the foam material, and a bottom channel running between the bottom panel and the foam material; and
e) a plurality of charging ports positioned at the bottom of the top and bottom channels, each of the charging ports electrically connected to the at least one power supply.

15. The portable charging station of claim 14, wherein each charging area has a top and a bottom; further wherein each charging area has an extension cut through the foam material from the charging area to an adjacent one of the top and bottom channels.

16. The portable charging station of claim 15, wherein the plurality of charging areas comprises a first set of charging areas and a second set of charging areas;
wherein in the first set of charging areas, the bottom of each charging area is in closer proximity to the top panel than the bottom panel of the case;
wherein in the second set of charging areas, the bottom of each charging area is in closer proximity to the bottom panel than the top panel of the case;
wherein each charging area of the first set of charging areas is alternating in position with a charging area of the second set of charging areas along the single row.

17. The portable charging station of claim 15, wherein the plurality of charging ports are arranged so a single charging port is positioned within one of the channels in closest proximity to the bottom of a single charging area.

18. The portable charging station of claim 15, further comprising a plurality of USB cords, each of the plurality of USB cords extending from a single charging port into an immediately adjacent charging area while passing through the extension of the immediately adjacent charging area.
